(19) United States
(12) Patent Application Publication
(10) Pub. No.: US 2007/0105717 A1
(43) Pub. Date: May 10, 2007

(54) Aqueous colorant compositions for use in seed treatment

(75) Inventors: Franz-Leo Heinrichs, Gablingen (DE); Armin Gramsamer, Gersthofen (DE); Olaf Mueller, Koenigstein (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant Produkte (Deutschland) GmbH

(21) Appl. No.: 11/586,410

(22) Filed: Oct. 25, 2006

(30) Foreign Application Priority Data
Oct. 25, 2005 (DE) 10 2005 050 995.9

(51) Int. Cl. A01N 25/26; C09B 67/00; C09D 201/00; C09D 101/00; C09D 4/00

(52) U.S. Cl. 504/100; 106/502

(57) ABSTRACT

Aqueous colorant compositions comprise at least one wax copolymer A, one colorant B, one film-forming wetting agent C and other additives standard for the preparation of aqueous colorant preparations which can be used for the dyeing of seed. The colorant compositions combine in themselves the properties of wax dispersions, polymer dispersions and colorant preparations. This means that they form a waxy film surface, have good adhesion, bring about a good distribution of active agent and colorant on the surface of the seed and display improved flow properties without a negative effect on the germination of the seed.

The present invention is described in the German priority application No.102005050995.9, filed 25.10.2005, which is hereby incorporated by reference as is fully disclosed herein.

The present invention relates to aqueous colorant compositions and to the use thereof in the treatment of seed, if appropriate in combination with plant protection agents.

In addition to the active agents as such, active agent formulations for seed treatment usually comprise colorants, wetting agents, dispersants, emulsifiers, antifoaming agents, preservatives, drying control agents, thickeners, solvents, adhesives and biodegradable polymers. To improve the distribution and adhesion, yet additional auxiliaries, such as wetting agents, dispersants or adhesives, are also used, however, in the seed treatment. Use is in particular made of adhesives to improve the adhesion. Synthetic polymers, such as poly(vinyl acetal)s, poly(vinyl alcohol)s, polyvinylpyrrolidones or alkylcellulose, are used as adhesives. These auxiliaries can be used with all types of the active agent formulation.

Use is made, as active agent formulations, of water- or oil-based dispersions SC, wettable powders WP, emulsifable concentrates EC, aqueous solutions SL, suspoemulsions SE, dustable powders DP, water-dispersible granules WG. Use is preferably made of water-based dispersions, the “fluid seed treatment” formulations.

For the operation of the seed treatment with active agent formulations, use is made of the processes conventionally used in practice, also described as seed dressing processes. Preferably, these can be:
dry seed dressings, preferably with addition of deposit builders, such as, e.g., paraffin oils or talc;
slurry seed dressings, preferably with addition of wetting agents, dispersants, emulsifiers, adhesives, inert fillers and colorants;
aqueous liquid seed dressings, preferably with addition of emulsifiers, dispersants, thickeners, antifreeze agents, polymers, adhesives and colorants;
solvent-comprising liquid seed dressings, preferably with addition of solvents and colorants;
emulsion seed dressings, preferably with addition of emulsifiers, solvents and colorants.

The seed dressings is carried out in seed dressing devices or drum mixers conventionally used in practice, such as, in the case of drum mixers, those standard in the building industry.

The arrangement of the individual processes and the additives necessary therefor are diverse and have again and again in the individual case to be suited to one another. In this connection, individual constituents definitely show a disadvantageous effect on the germination behavior of the treated seed.

It is known in particular that the expenditure of an excessively large amount of adhesives admittedly improves the adhesion but can interfere in a disadvantageous way with the germination. It is likewise known that wetting agents and dispersants can promote the migration of active agents into the seed and accordingly can likewise have a disadvantageous effect on the germination. Also, it often cannot be predicted how the ingredients of the colorants or adhesive formulations have an effect on the germination behavior.

It is therefore the object to develop a simple well-tolerated binder/adhesive system, if appropriate combined with colorants, in order to reduce the complexity of the seed dressing and simultaneously thereby to improve the seed dressing action of the active agent formulations without, however, disadvantageously changing in this connection the germination behavior of the seed.

This object is achieved by an aqueous colorant composition which comprises at least one wax copolymer A, one colorant B and one film-forming wetting agent C, in addition to other additives standard for the preparation of aqueous colorant preparations.

The colorant composition according to the invention is suitable for use in combination with simplified seed dressing formulations, especially with commercially available fungicides and insecticides, and meets the requirements imposed. The system of colorant composition according to the invention and seed dressing can be combined with all types of formulations, dry, slurried, dispersed or in solution. Surprisingly, the active agent is uniformly distributed and is attached in a film to the surface of the seed. Film formation takes place very quickly and the dressed seed is not sticky and is easy to convey. Above all, the germinating power of the seed treated with the colorant composition according to the invention is not thereby worsened; on the contrary, the germination behavior becomes even more standardized.

The colorant composition preferably comprises, as wax copolymer A, the reaction product of a polyol wax ester acrylate, alkyl acrylate/styrene or acrylic acid. This polymer forms a film with crystalline regions which behaves like the natural wax layer of plants and seed grains for the exchange of material of the seed grain with its surroundings.

The colorant composition according to the invention comprises, as colorant B, for application to seed, standard pigments in the form of powders or aqueous preparations. Undesirable sedimentation could not be observed.

The colorant composition according to the invention comprises, as film-forming wetting agent C, preferably waxy ethoxylates, such as, e.g., montan wax acid ethoxylate, wax alcohol ethoxylate or wax ethoxylate. The ethoxylate component assists both the distribution of the active agent and the exchange of material and above all the uptake of moisture, while the wax component can combine well with the polymer and contributes to film formation.

The colorant composition according to the invention simplifies the seed dressing to a considerable extent. The seed dressing can be combined both dyed and neutral. The result is in each case a seed on which the active agent and the colorant are homogeneously distributed, which is protected against abrasion, which guarantees uniform and fast germination and which is attractively fashioned visually.

### IMPLEMENTATIONAL EXAMPLES

Starting Material 1:

Styrene/acrylate wax copolymer with MFT 32

| Substance | Amount |
|---|---|
| Reactive wax dispersion | 450 |
| Dispersogen LFES | 52.89 |
| Monomer 1 | 70.1 |
| Monomer 2 | 397.8 |
| Ammonium peroxodisulfate | 1.5 |
| Deionized water | 1019.36 |
| Ascorbic acid | 1.4 |
| 30% H₂O₂ | 6.95 |
| 25% Ammonia | |
| Saniprot 94-08 | 0.6 |

Monomer composition:

| | | |
|---|---|---|
| Styrene | styrene | 99.4 |
| Methyl methacrylate | MMA | 124.5 |
| Ethyl acrylate | EA | 257.5 |
| Methacrylic acid | MAA | 3.5 |

| | |
|---|---|
| Viscosity: | 150 cPs, |
| Solids: | approx. 30%, |
| Transparency: | approx. 55% in 1% |
| | dilution, |
| Density: | approx. 1.03 kg/l |
| MFT: | approx. 32 |

Starting Material 2:

Wax ethoxylate dispersion based on ethoxylated montan wax acid

Substance:

| | |
|---|---|
| Montan wax acid EO 25 | 30 |
| Water | 70 |

Starting Material 3:

Wax ethoxylate dispersion based on ethoxylated wax alcohols
Substance:

| | |
|---|---|
| Wax alcohol EO 50 | 30 |
| Water | 70 |

Starting Material 4:

| | |
|---|---|
| Wax copolymer dispersion according to starting material 1 | 33.5 |
| Wax ethoxylate dispersion according to starting material 2 | 33.5 |
| Water | 33 |

Starting Material 5:

| | |
|---|---|
| Wax copolymer dispersion according to starting material 1 | 50 |
| Wax ethoxylate dispersion according to starting material 2 | 50 |

Starting Material 6:

| | |
|---|---|
| Wax copolymer dispersion according to starting material 1 | 35 |
| Wax ethoxylate dispersion according to starting material 3 | 20 |
| Fatty alcohol ethoxylate | 15 |
| Water | 30 |

Colorant compositions according to the invention, examples P1 to P7:

Preparations for wheat

| | P1 | P2 | P3 | P4 | P5 | P6 | P7 |
|---|---|---|---|---|---|---|---|
| Flexonyl Orange G100 | 0.5 | | | | | | |
| Flexonyl Red A-LCLL | | 0.5 | | | 0.5 | 0.5 | |
| Flexonyl Red FGR131 | | | | | | | 0.5 |
| Viscofil Red A- | | | 0.5 | | | | |
| WTS 30 | | | | | | | |
| Sandosperse Rubine | | | | 0.5 | | | |
| WF571 | | | | | | | |
| Water | 0.75 | 0.75 | 0.75 | 0.75 | 0.75 | 0.75 | 0.75 |
| Dispersion according | | | | | 4 | 4 | 4 |
| to starting material 4 | | | | | | | |
| Dispersion according | 1 | 1 | 1 | 1 | | | |
| to starting material 5 | | | | | | | |

For the dyeing of wheat, the colorant compositions according to the invention were adjusted so that the pigment content is 1 to 6%, so that 5 to 30 g of pigment per t are used.

Wheat seed treatment: (1000 parts by weight of wheat receive the parts by weight of coating substance given in the table)

| | | | | | | | |
|---|---|---|---|---|---|---|---|
| Wheat | 1000 | 1000 | 1000 | 1000 | 1000 | 1000 | 1000 |
| Colorless active agent | 1 | 1 | 1 | 1 | 1 | 1 | 1 |
| Preparation according | P1 | P2 | P3 | P4 | P5 | P6 | P7 |
| to | 2.25 | 2.25 | 2.25 | 2.25 | 5.25 | 5.25 | 5.25 |
| | 0.75 | 0.75 | 0.75 | 0.75 | 0.75 | 0.75 | 0.75 |
| Filler: talc | 1 | 1 | 1 | 1 | 0 | 2 | 2 |
| Water | | | | | | | |

The active agent was diluted with water, combined with the colorant composition and charged to the rotating mixture of wheat and talc in the seed mixer.

For comparison, a mixture of 2 parts of colored active agent preparation Landor CT mixed with 2 parts of water was applied. The pigment content was the same in all applications.

It was ascertained that, on using the preparation according to the invention, the coating was more uniform, the color more intense and the frictional characteristics improved. The drying time was shortened.

In comparison with the use of commercially available adhesives, the drying behavior and the flow behavior were clearly improved.

Colorant compositions according to the invention P8 to P15:

Preparations for corn

| | P8 | P9 | P10 | P11 | P12 | P13 | P14 | P15 |
|---|---|---|---|---|---|---|---|---|
| Flexonyl Orange | | 1.5 | | | | | | |
| G100 | | | | | | | | |
| Flexonyl Red A- | | | 1.5 | | | | | |
| LCLL | | | | | | | | |
| Viscofil Red A- | 1.5 | | | | | | | |
| WTS 30 | | | | | | | | |
| Sandosperse Rubine | | | | 1.5 | | | | |
| WF571 | | | | | | | | |
| Colanyl Red FGR | | | | | 1.5 | | | |
| 131 | | | | | | | | |
| Viscofil Orange | | | | | | 1.5 | | |
| S-RL | | | | | | | | |
| Viscofil Violet BLN | | | | | | | 1.5 | |
| Viscofil Blue A- | | | | | | | | 1.5 |
| BGS | | | | | | | | |
| Dispersion | 1.5 | 1.5 | 1.5 | 1.5 | 1.5 | 1.5 | 1.5 | 1.5 |
| according to 4 | | | | | | | | |
| Water | 3.0 | 3.0 | 3.0 | 3.0 | 3.0 | 3.0 | 3.0 | 3.0 |
| Colorless sheet | | | | | | | 5 | |
| silicate | | | | | | | | |
| Colored sheet | | | | | | | | 5 |
| silicate | | | | | | | | |

Corn seed dressing with colored additive: (1000 parts by weight of corn receive the parts by weight of coating substance given in the table)

| | | | | | | | |
|---|---|---|---|---|---|---|---|
| Corn | 1000 | 1000 | 1000 | 1000 | 1000 | 1000 | 1000 |
| Colorless active | 10 | 10 | 10 | 10 | 10 | 10 | 10 |
| agent | | | | | | | |
| Preparation | P8 | P9 | P10 | P11 | P12 | P13 | P14 |
| according to | | | | | | | |
| | 6 | 6 | 6 | 6 | 6 | 6 | 6 |
| Filler: talc | 20 | 20 | 20 | 20 | 20 | 20 | 20 |
| Water | 20 | 20 | 20 | 20 | 20 | 20 | 20 |
| Dispersion | 5 | 5 | 5 | 5 | 5 | 5 | 5 |
| according to 4 | | | | | | | |

Water and copolymer dispersion according to example 1 were mixed. The corn was added to the mixing vessel and moistened with 10 parts of the water-copolymer mixture. The talc was then added. The remainder of the water-copolymer mixture was combined with the active agent and the colorant preparation and likewise added to the mixer over a period of time of 15 s. Stirring was then carried out for a further 15 s and then the mixer was emptied.

Corn seed dressing with colored active agent: (1000 parts by weight of corn receive the parts by weight of coating substance given in the table)

| | Corn | | |
|---|---|---|---|
| | 1000 | 1000 | 1000 |
| Active agent: Mesurol | 10 | 10 | 10 |
| Dispersion according to 4 | 0 | 1.5 | 5 |
| Filler: talc | 0 | 10 | 15 |
| Water | 10 | 20 | 25 |

Water and copolymer dispersion according to example 1 were mixed. The corn was added to the mixing vessel and moistened with 10 parts of the water-copolymer mixture. The talc was then added. The remainder of the water-copolymer mixture was combined with the active agent and likewise added to the mixer over 15 s. Stirring was then carried out for a further 15 s and then the mixer was emptied.

Corn seed dressing with colored additive and effect additives: (1000 parts by weight of corn receive the parts by weight of coating substance given in the table)

Corn

| | 1000 | 1000 |
|---|---|---|
| Colorless active agent | 10 | 10 |
| Preparation according to | P14 | P15 |
| Filler: talc | 10 | 10 |
| Water | 20 | 20 |
| Dispersion according to 4 | 5 | 3 |

Water and copolymer dispersion according to example 1 were mixed. The corn was added to the mixing vessel and moistened with 10 parts of the water-copolymer mixture. The talc was then added. The remainder of the water-copolymer mixture was combined with the active agent and the colorant preparation and likewise added to the mixer over 15 s. Stirring was then carried out for a further 15 s and then the mixer was emptied.

Evaluation:

Mesurol, dyed red, is applied, with 10 to 20 ml/kg of corn, according to the manufacturer's recommendations. In practice, fillers, such as powdered stone or talc, are added since the drying and adhesion of the formulation are rated as too poor.

A visible improvement could already be achieved by the addition of copolymer dispersion according to examples 1 and 2. Ever better results are achieved if the active agent is formulated colorless and combined with the finished colorant preparation according to the invention. A rapidly drying seed with a coating possessing good adhesive and frictional properties is obtained. Abrasion is noticeably lower than with the seed dressing according to the manufacturer's recommendations.

In the same way, processing can also be carried out with other seed dressing active agents formulated in liquid form or even dry seed dressing active agents.

Colorant compositions according to the invention P16 to P25:

Preparations for Rape

| | Preparation | | | | | | | | | |
|---|---|---|---|---|---|---|---|---|---|---|
| | P16 | P17 | P18 | P19 | P20 | P21 | P22 | P23 | P24 | P25 |
| Flexonyl | 1.5 | | | | | | | | | |
| Orange G100 | | | | | | | | | | |
| Viscofil Red A- | | 1.5 | | | | | | | | |
| WTS 30 | | | | | | | | | | |
| Colanyl Yellow | | | 1.5 | | | | | | | |
| 2GXD500 | | | | | | | | | | |
| Colanyl Red | | | | 1.5 | | | | | | |
| FGR131 | | | | | | | | | | |
| Viscofil Orange | | | | | 1.5 | | | | | |
| S-RL | | | | | | | | | | |
| Viscofil Orange | | | | | | 1.5 | | | | |
| pigment | | | | | | | | | | |
| dispersion | | | | | | | | | | |
| Viscofil Green | | | | | | | 1.5 | | | |
| A-GNS | | | | | | | | | | |
| Viscofil Violet | | | | | | | | 1.5 | | |
| BLN | | | | | | | | | | |
| Viscofil Blue A- | | | | | | | | | 1.5 | |
| BGS | | | | | | | | | | |
| Flexonyl White | | | | | | | | | | 1.5 |
| RS | | | | | | | | | | |
| Water | 3 | 3 | 3 | 3 | 10 | 3 | 3 | 10 | 10 | 3 |
| Colorless sheet | | | | | 10 | | | | | |
| silicate | | | | | | | | | | |
| Blue sheet | | | | | | | | 10 | 10 | |
| silicate | | | | | | | | | | |
| Dispersion | 1.5 | 1.5 | 1.5 | 1.5 | 1.5 | 1.5 | 1.5 | 1.5 | 1.5 | 1.5 |
| according to | | | | | | | | | | |
| example 4 | | | | | | | | | | |

Rape Seed Dressing with Colored Additive:

| | | | | | | | |
|---|---|---|---|---|---|---|---|
| Rape | 1000 | 1000 | 1000 | 1000 | 1000 | 1000 | 1000 |
| Colorless | 5 | 5 | 5 | 5 | 5 | 5 | 5 |
| active agent | | | | | | | |
| Preparation according to | P16 | P17 | P18 | P19 | P20 | P21 | P22 |
| | 6 | 6 | 6 | 6 | 23 | 6 | 6 |
| Filler: talc | 17 | 17 | 17 | 17 | 17 | 17 | 17 |
| Water | 25 | 25 | 25 | 25 | 15 | 25 | 25 |
| Dispersion | 1.5 | 1.5 | 1.5 | 1.5 | 2 | 1.5 | 1.5 |
| according to 5 | | | | | | | |

Water and copolymer dispersion according to example 1 were mixed. The rape was added to the mixing vessel and moistened with 10 parts of the water-copolymer mixture. The talc was then added. The remainder of the water-copolymer mixture was combined with the active agent and the colorant preparation and likewise added to the mixer over 15 s. Stirring was then carried out for a further 15 s and then the mixer was emptied.

Rape Seed Dressing with Colored Active Agent:

| | Rape | | |
|---|---|---|---|
| | 1000 | 1000 | 1000 |
| Active agent: Chinook | 20 | 20 | 20 |
| Dispersion according to 6 | 0 | 1.5 | 5 |
| Filler: talc | 20 | 20 | 25 |
| Water | 10 | 20 | 25 |

Water and copolymer dispersion according to example 1 were mixed. The rape was added to the mixing vessel and moistened with 10 parts of the water-copolymer mixture. The talc was then added. The remainder of the water-copolymer mixture was combined with the active agent and likewise added to the mixer over 15 s. Stirring was then carried out for a further 15 s and then the mixer was emptied. The distribution and adhesion were improved by the addition of the copolymer dispersion. The seed was shinier.

Rape Seed Dressing with Colored Additive and Effect Additive:

Rape

| | 1000 | 1000 |
|---|---|---|
| Colorless active agent | 5 | 5 |
| Preparation according to | P23 | P24 |
| | 23 | 23 |
| Filler: talc | 20 | 20 |
| Water | 15 | 15 |
| Dispersion according to 5 | 2 | 2 |

Water and copolymer dispersion according to example 1 were mixed.

The rape was added to the mixing vessel and moistened with 10 parts of the water-copolymer mixture. The talc was then added. The remainder of the water-copolymer mixture was combined with the active agent and the colorant preparation and likewise added to the mixer over 15 s. Stirring was then carried out for a further 15 s and then the mixer was emptied.

Germinating trials were carried out on all seed varieties treated. No difference was determined from the products dressed according to the recommendations.

Colorants Used:

The following colorants were used for the preparation of the colored colorant compositions according to the invention. They are commercial products from Clariant.

Flexonyl Orange G100

Flexonyl Red A-LCLL

Flexonyl Red FGR131

Flexonyl White RS

Colanyl Yellow 2GXD500

Colanyl Red FGR131

Viscofil Orange S-RL

Viscofil Orange pigment dispersion

Viscofil Red A-WTS 30

Viscofil Green A-GNS

Viscofil Violet BLN

Viscofil Blue A-BGS

The mica pigments from Eckart listed below were used to achieve optical effects:

Pearlescent pigment PX1000

Pearlescent pigment Amethyst

Fillers Used:

Talc, commercial (plastic grade)

Limestone, commercial (plastic grade)

Powdered stone, commercial (fertilizer grade)

Active Agents Used:

Landor CT/Bayer

with the active agent combination fludioxonil, difenoconazole, tebuconazole

Solitär/Bayer

with the active agent combination fludioxonil, cyprodinil, tebuconazole

Arena/Bayer

with the active agent combination fludioxonil, tebuconazole

Baytan/Bayer

with the active agent combination fuberidazole, imazalil, triadimenol

Mesurol/Bayer

with the active agent methiocarb

Chinook/Bayer

with the active agent combination beta-cyfluthrin, imidacloprid

Monceren/Bayer

1. An aqueous colorant composition, comprising at least
wax copolymer A,
colorant B,
film-forming wetting agent C
and other additives standard for the preparation of aqueous colorant preparations.

2. An aqueous colorant composition as claimed in claim 1, wherein the wax copolymer A is a polymer of polymerizable wax compounds with ethylenically unsaturated acids.

3. An aqueous colorant composition as claimed in claim 1 wherein colorant B is a pigment powder or an aqueous pigment preparation.

4. An aqueous colorant composition as claimed in claim 1, wherein colorant B is a dye.

5. An aqueous colorant composition as claimed in claim 1, wherein the film-forming wetting agent C is an ethoxylated wax or ethoxylated fatty derivative.

6. An aqueous colorant composition as claimed in claim 1, comprising wax copolymer A in an amount of 1 to 99% by weight, colorant B in an amount of 0.1 to 40% by weight and film-forming wetting agent C in an amount of 1 to 60% by weight, in each case based on the solids content of the aqueous colorant composition.

7. Seed dyed by an aqueous colorant composition as claimed in claim 1.

8. A seed dressing composition comprising an aqueous colorant composition as claimed in claim 1 and a plant protection active agent.

9. A colorant composition as claimed in claim 2, wherein the ethylenically unsaturated acids are acrylic acid, methacrylic acid or derivatives thereof.

10. A colorant composition as claimed in claim 9, wherein the derivatives are acrylate esters, acrylamides, methacrylate esters, styrene or styrene derivatives.

11. An aqueous colorant composition, comprising
at least one wax copolymer A,
at least one colorant B.,
at least one film-forming wetting agent C
and at least one additive standard for the preparation of an aqueous colorant preparation.

12. An aqueous colorant composition, comprising
at least one wax copolymer A,
at least one colorant B, and
at least one film-forming wetting agent C.

13. Seed dyed by an aqueous colorant composition as claimed in claim 11.

14. Seed dyed by an aqueous colorant composition as claimed in claim 12.

15. A seed dressing composition comprising an aqueous colorant composition as claimed in claim 11 and a plant protection active agent.

16. A seed dressing composition comprising an aqueous colorant composition as claimed in claim 12 and a plant protection active agent.
